(19) United States
(12) Patent Application Publication
(10) Pub. No.: US 2010/0181730 A1
(43) Pub. Date: Jul. 22, 2010

(54) BEARING SEAL

(76) Inventor: Alan James Roddis, Sheffield (GB)

Correspondence Address: EDWIN D. SCHINDLER, FIVE HIRSCH AVENUE, P.O. BOX 966, CORAM, NY, 11727-0966, US

(21) Appl. No.: 12/665,571

(22) PCT Filed: Jun. 13, 2008
(86) PCT No.: PCT/GB08/02062

§ 371 Date: Jan. 7, 2010

(30) Foreign Application Priority Data
Jun. 18, 2007 (GB) 0711755.9

(51) Int. Cl. F16J 15/447

(52) U.S. Cl. 277/412

(57) ABSTRACT

A non-contacting sealing device for a bearing includes a labyrinth seal with a static shut-off device. The non-contacting sealing, or isolator, device includes stator, a rotor and the static shut-office device, which includes at least one deformable toroidal member adjacent to the stator surface and adjacent to the rotor surface. The deformable toroidal member engages both the stator surface and the rotor surface when the rotor is static and disengages at least one of the stator surface and the rotor surface when the rotor is operational. The seal may be an integral part of the bearing, or a substantially attachable member to a bearing.

### FIELD OF THE INVENTION

This invention relates to bearings, specifically the integral seal adjacent to the bearing balls/rollers, which prevents the egress of a lubrication fluid, such as grease, from the bearing, or prevents the ingress of moisture to the bearing resulting in deterioration of bearing life. A bearing with integral seals, positioned at each longitudinal opening of the bearing, is typically referred as a sealed for life bearing. The invention is specifically related to bearings, which are intended to be sealed for life.

### BACKGROUND TO THE INVENTION

The primary purpose of an integral bearing seal fitted in a bearing, is to prevent the egress of fluid, specifically grease lubricant from leaving the bearing. Hence as the terminology ‘sealed for life’ implies it is the design intent that the bearing doesn't need constant lubrication application as the integral bearing seals keep the lubricant contained.

A sealed for life bearing is almost always supplied with two integral, and replaceable contacting lip-type seal devices, typically manufactured from an elastomeric type material. These devices are fitted between the bearing outer race and inner race and form sealing contact between the counter rotational surfaces.

Like all contacting elastomeric type seals, their life expectancy is limited to the operational conditions of the bearing. Often, in high speed applications, the contact lip-type seals deteriorate very quickly. This deterioration permits grease to leave the bearings which reduces the intended bearing lubrication regime and thus will reduce the bearing life.

Furthermore, as the balls/rollers within the bearing rotate, frictional heat is generated. A contacting lip-seal, positioned either side of the bearing not only increases the assembly heat generation given the additional frictional heat generated by the seals, the seals act to contain the heat within the bearing. This heat accelerates the lip-seal deterioration process.

As the lip-seal deteriorates, it permits water and moisture ingress, which again deteriorates the bearing life.

As most lip-seals act, hence have the lip positioned to retain the grease, they permit water ingress when subject to a forced water spray.

It is therefore deemed considerably advantageous if a non-contacting seal arrangement is used as the integral seal between the inner and outer bearing races.

As bearings operate the lubrication fluid and air in the bearing expands as it warms. In a traditional labyrinth seal arrangement this expansion will expel air through the labyrinth and “breath” out of the bearing chamber. Once the equipment stops, the bearing chamber cools and the air inside contracts, sucking moist air past the labyrinth arrangement and back into the bearing chamber. This is referred as “breathing” in.

Said non-contacting bearing seal should preferably prevent moisture ingress and/or lubricant egress during bearing idle and operational duties.

Preferably, said non-contacting seal should be retrofittable into existing bearing races and ideally be longitudinal movement and angular tolerance, to accommodate tolerance stackups with the bearing.

Preferably, said non-contacting seal should be of a labyrinth construction, with two or more components, one of which is mounted for rotation about the inner bearing race and axially fixed in relation thereto and the other is mounted about the outer race and is also axially fixed in relation thereto. Preferably, the rotating component typically has a complex outer profile which is located adjacent and in close radial and axial proximity to a complex inner profile of the stationary component. Together these complex profiles, in theory, provide a tortuous path preventing the passage of the unwanted materials or fluids.

### STATEMENTS OF THE INVENTION

According to the present invention there is provided a non-contacting bearing sealing device comprising of a labyrinth seal and a static shut-off device.

Although reference is made herein to an elastomer or o-ring forming the static shut-off device, it would be understood that any elastomeric or solid deformable material may be provided. Furthermore, the physical shape of the static shut-off device is illustrated as circular, however again it would be understood that any number of shapes, including any combination of flat or circular surfaces, may be provided.

Preferably the rotor comprises of one monolithic piece and the stator is one monolithic piece.

Preferably the rotor and the stator are axially restrained to the inner and outer races of a bearing.

Preferably the static shut-off device comprises an elastomer which is radially located in a “v” shape positioned radially inwardly of said elastomer. Said “v” shape is composed of two counter rotating surfaces. Said elastomer radially rests on said “v” shape at a slightly larger radial position than the nominal radial position of the elastomer in its free state.

Preferably two or more adjacently disposed static shut-off devices are incorporated into the bearing seal, one inwardly radially disposed about the other.

Preferably the static shut-off device comprises an elastomer which is radially located between a cylindrical surface of the stator and a cylindrical surface of the rotor. Said elastomer radially sealingly engages said stator surface when the bearing is idle and disengages said surface when the equipment is in operation.

Preferably the static shut-off device comprises a first elastomer which is radially located between two radially disposed cylindrical surfaces of the rotor and a second elastomer adjacently in contact with said first elastomer. Said first elastomer sealingly engages a stator surface when the equipment is idle and disengages said stator surface with the equipment is operational.

The bearing seal preferably includes a stator, which has a substantially male circumferential location feature which corresponds to a substantially female location feature on the outer race of a bearing. It is preferable that said two locations have a radial interference thereby creating a sealable joint.

Preferably the stator housing contains at least one radial communication feature which communicates the inner most surface of the stator member to the outer most surface of the stator member.

Preferably the rotor contains at least one radially extending feature on its outer surface, said feature is positioned adjacent and in close proximity to an inner surface of the stator.

The seal may be an integral part of the bearing or a substantially attachable member to a bearing. In a preferred embodiment, the overall length of the bearing is not greater than the commercially available lengths shown in ISO/ANSI standards and major bearing supplier catalogues.

Embodiments of labyrinth seals in accordance with the present invention may be such that at least one rotary member and/or one stationary member can be mechanically attached to the items of the bearing.

The invention also provides a bearing seal in the form of a non-contacting labyrinth-type seal, which is of the invention.

### DESCRIPTION OF THE DRAWINGS

The accompanying drawings are as follows:

FIG. 1 is a half longitudinal cross section view of a prior art bearing with integral elastomeric lip-type seals;

FIG. 2 is a longitudinal cross section of a bearing with a non-contacting seal of the invention;

FIG. 3 corresponds to FIG. 2 and shows an enlarged view of the seal of the invention;

FIG. 4 corresponds to FIG. 2 and shows an alternative enlarged view of the seal drainage orifice of the invention;

FIG. 5 is a longitudinal cross section of an alternate bearing with a non-contacting seal of the invention;

FIG. 6 corresponds to FIG. 5 and shows an enlarged view of the seal of the invention;

FIG. 7 is a longitudinal cross section of a bearing with an alternate non-contacting seal of the invention;

FIG. 8 is a longitudinal cross section of a bearing with an alternate and substantially integral non-contacting seal of the invention;

FIG. 9 is a longitudinal cross section of a bearing with an alternate non-contacting seal of the invention;

FIG. 10 is a longitudinal cross section of a bearing with an alternate non-contacting seal of the invention;

FIG. 11 is a longitudinal cross section of a bearing with an alternate non-contacting seal with integral lip type seal of the invention;

FIG. 12 corresponds to FIG. 2 but shows an alternate longitudinal cross section of a bearing with a pressed steel bearing seal of the invention;

### DETAILED DESCRIPTION OF THE INVENTION

The invention will now be described, by way of examples only, with reference to the accompanying drawings.

In general bearing seals in accordance with the present invention may be used not only in the case where the inner bearing race is a rotary member and the outer bearing race is a stationary member but also the reverse situation, that is to say, in which the inner bearing race is stationary and the outer bearing race is rotary.

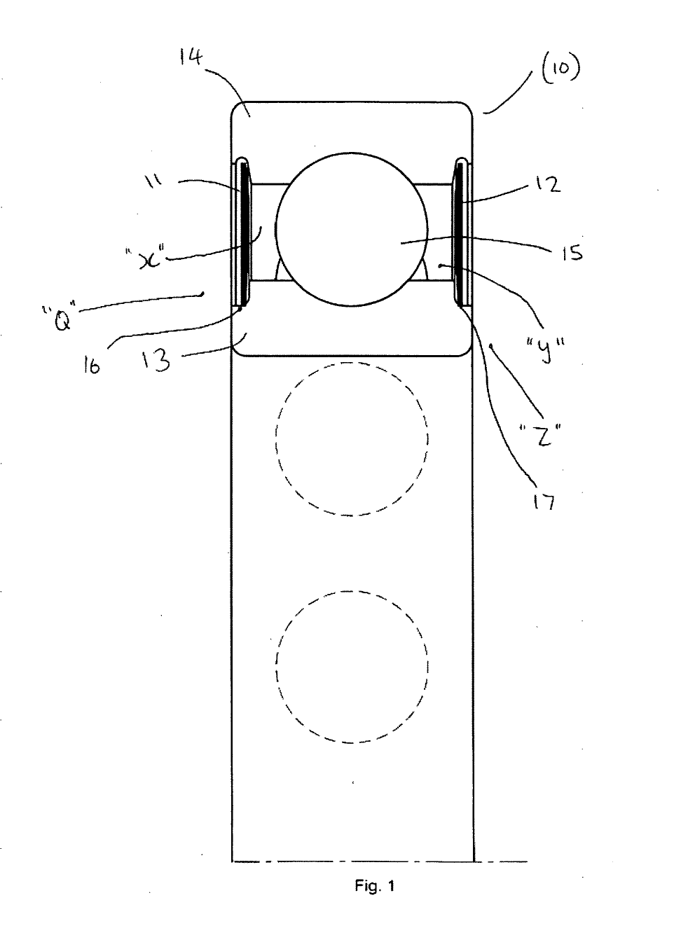

Referring to FIG. 1 of the accompanying drawings, there is illustrated a prior art bearing 10 with integral bearing seal 11 and 12. The bearing has an inner race 13 and outer race 14, and one or more rolling elements 15 spaced in-between.

Area “X” and “Y” adjacent to the rolling elements 15 is typically filled with bearing grease lubricant.

Outside the bearing in areas “Z” and “Q” there could be fluid and/or solids and/or foreign debris and/or atmosphere. However, for clarity it will herewith be termed “atmospheric substance”, being used to describe the single or mixed medium.

The integral bearing seal 11 and 12 makes a counter rotational contact on the inner race 13 at points 16 and 17. In certain operating conditions this leads to rapid wear of the seals 11,12 and/or inner race 13 members. This wear permits either moisture entry into the bearing lubricant or bearing lubricant egress into the atmosphere.

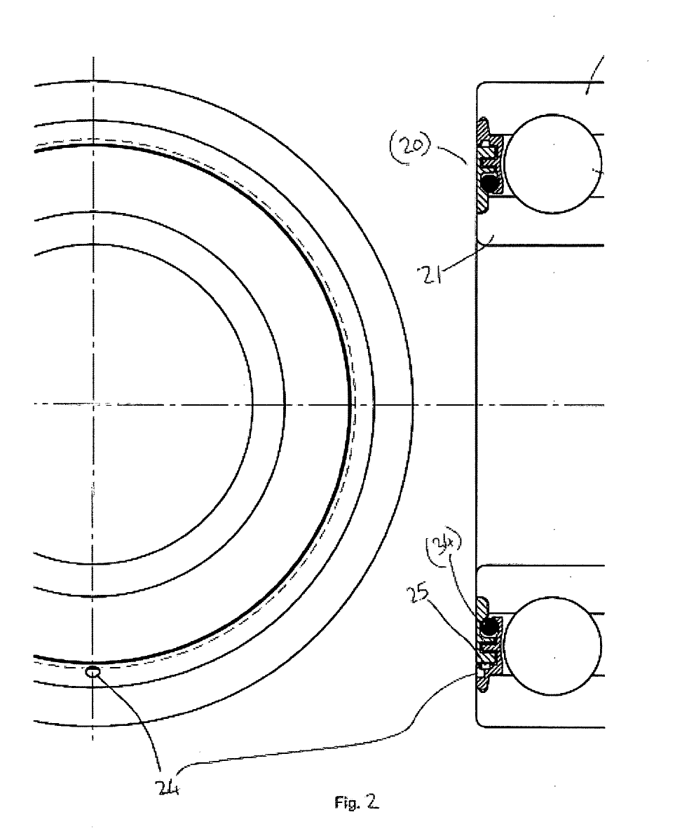

FIG. 2 is a longitudinal cross section of a bearing showing a non-contacting seal 20 of the invention.

The bearing assembly comprises of an inner race 21 and a outer race 22 with one or more rolling elements 23 disposed in-between said inner 21 and outer 22 races.

In the preferred embodiment, the bearing seal 20 is located in the existing bearing location grooves as the previously shown lip-type seal of FIG. 1. This modularity is an important aspect of the invention given it enables a user to upgrade the bearings sealing mechanism without changing the bearing. It also means that the original bearing manufacturers do not need to re-machine new bearings, requiring new tooling, given a great deal of the existing designs will be in the field in customers premises and in their inventory.

From FIG. 2, a drain orifice 24 is preferably included in the bearing seal 20 adjacent to the atmospheric side of the rolling balls/rollers 23 and is preferably positioned at the 6 o'clock position in the end view. This drain orifice is preferably positioned adjacent to a velocity reducing groove 25, the intent of which is to permit the drainage of any water/moisture particles that enter the bearing seal 20 before said moisture contacts the shut off valve 34.

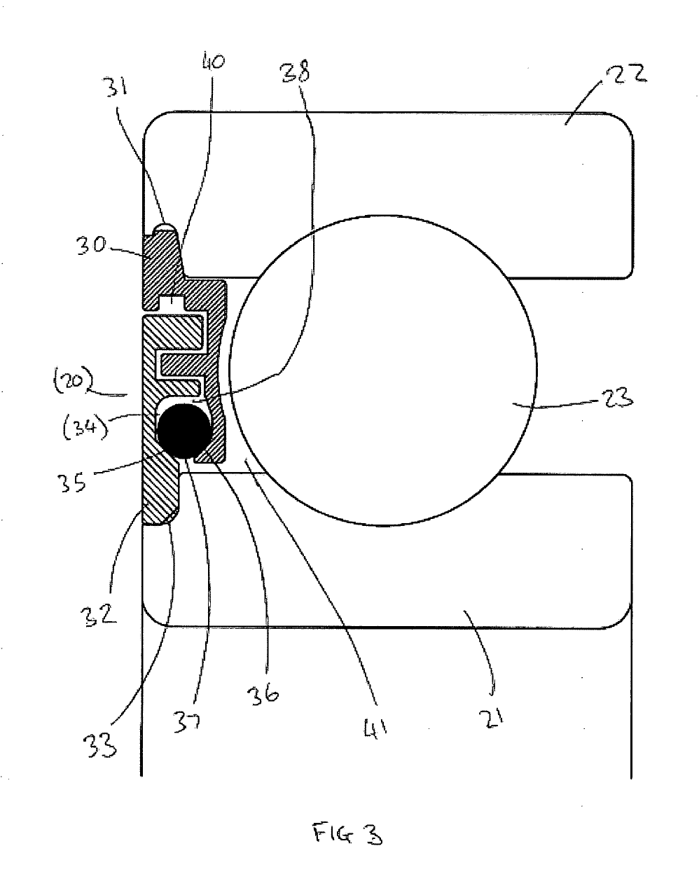

FIG. 3 corresponds to FIG. 2 and shows an enlarged view of the bearing seal 20 of the invention. From FIG. 3, the bearing seal comprises of a stator member 30 which clips into the radial groove 31 of outer race 22, and a rotor member 32 which engages in the inner race 21 location feature 33.

A static-shut off valve 34 is formed between the rotor surface 35 and stator surface 36 and an elastomeric member 37 which sits in sealing engagement between two aforementioned surfaces in the bearing idle position.

As the bearing operates, said elastomer 37 is subjected to the centrifugal forces of the rotor member 32 and therefore it radially extends into radial space 38. This disengages the sealing surface between said elastomer 37 and said stator surface 36, providing a substantially non-contacting sealing device.

Radially disposed to elastomer 37, preferably on the atmospheric side of the bearing, is a series of longitudinal and radial castellations between said rotor 32 and stator 30 thereby forming a tortuous labyrinth to prevent moisture entry.

Preferably the velocity reducing groove 40 is positioned on the atmospheric side of the rolling ball/roller element 23 to act to prevent water spray from entering the labyrinth.

Preferably the static shut off valve 34 is positioned on the grease/lubrication side of the rolling ball/roller element 23. It is not unusual for operators in the field to over grease such bearings filling the bearing cavity 41 until bearing lubricant visibly comes through the sealing element.

The experienced reader will note that in such over lubrication applications, the grease lubricant in bearing cavity 41 is on the inner most radial area of the static shut off valve 34. As the grease is applied, it therefore acts to radially displace the static off valve, raising it off its v-seat. This allows grease lubricant to pass around the sides of the elastomer 37, through the labyrinth, and out into the atmosphere, thereby providing a visual indication to the operator that the bearing cavity is full of grease. This is deemed to be advantageous specifically given the proximity of the sealing element to the rolling ball/roller element 23.

It is also deemed to be specifically advantageous to ensure an adequate, non-castellated area on the lubrication side of the shut-off valve elastomer 37, so to provide a sufficient area for which the grease can act.

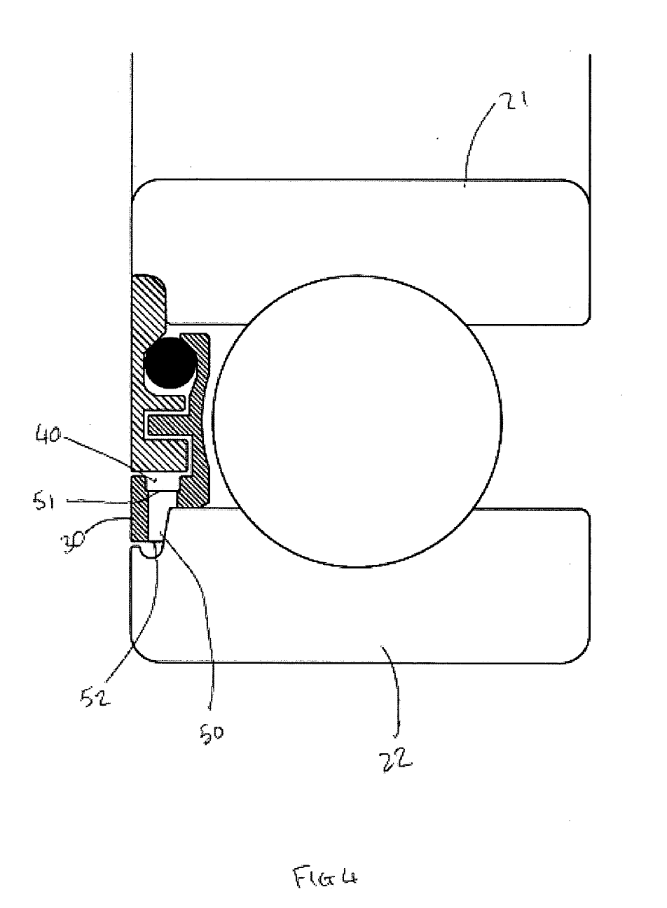

FIG. 4 corresponds to FIG. 2 and shows an alternative enlarged lower cross sectional view of the seal drainage orifice 50 of the invention.

From FIG. 4, the orifice radially communicates between the outer most radial surface 51 of velocity reducing cavity 40 and the outer most radial surface 52 of the stator 30. Preferably, a radial gap between the bearing outer race 22 and the outer most radial surface 52 exists to permit any moisture collated in velocity reducing cavity 40 to exit through the communication orifice 50 and back to atmosphere.

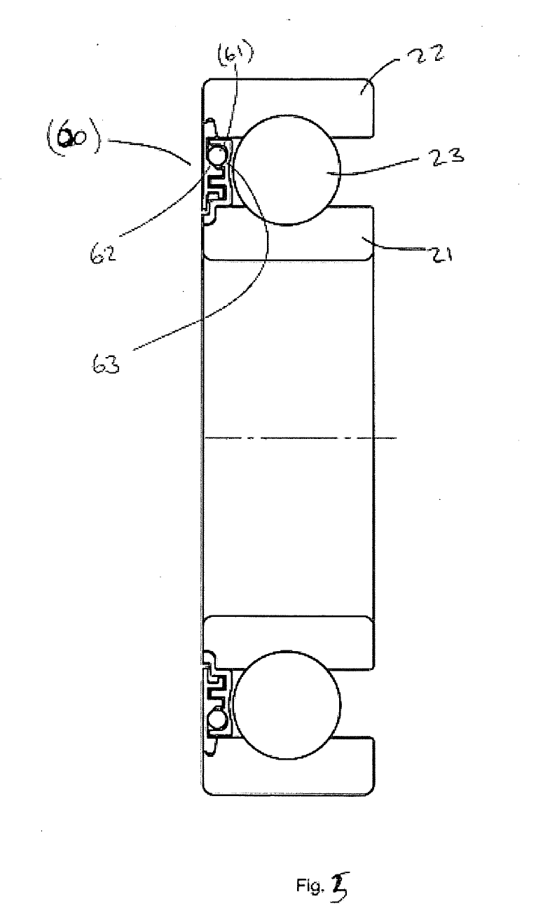

FIG. 5 is a longitudinal cross section of an alternate bearing with a non-contacting seal 60 of the invention whereby the grease lubricant applied to the bearing rolling ball/roller elements 23 is positioned on the outer most radial surface of the static shut off valve 61. This means that as the lubricant is applied it acts to close the static shut off valve against the corresponding v-seats 62 and 63. This acts as a positive stop for the grease application.

Clearly, the experienced reader will now see a significant advantage over the existing prior art lip-type seal in FIG. 1, in that at one side of the bearing rolling ball/roller elements 23 a seal of embodiment of FIG. 3 can be applied whilst at the other side of the bearing rolling ball/roller elements 23 a seal of the embodiment of FIG. 5 can be applied. This means that the grease applied is positively forced around the entire bearing longitudinal cavity, stopping at one side of the ball/roller bearings 23 whilst exiting at the other side of the ball/roller bearings 23. This combination embodiment acts as a lubrication purge system, to ensure lubricant application consistency.

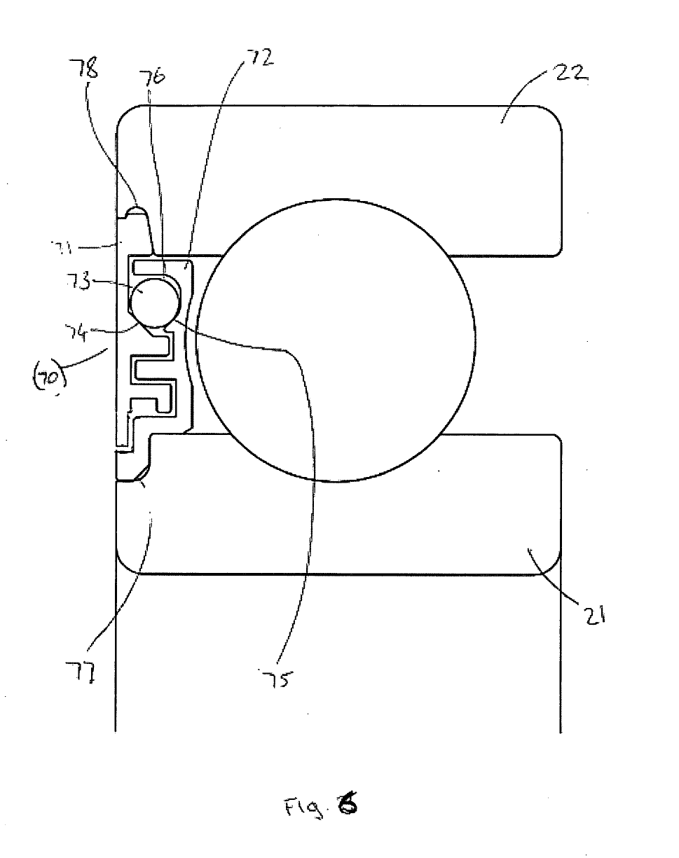

FIG. 6 corresponds to FIG. 5 and shows an enlarged view of the seal 70 of the invention with a stator 71 and rotor 72, an elastomer 73 which seats on surfaces 74 and 75 when the bearing is idle, and lifts from said surfaces 74 and 75 into radial gap 76 when the bearing is operational.

As previously described, said rotor 72 locates in bearing inner race 21 in groove 77 and said stator 71 locates in bearing outer race 22 in groove 78.

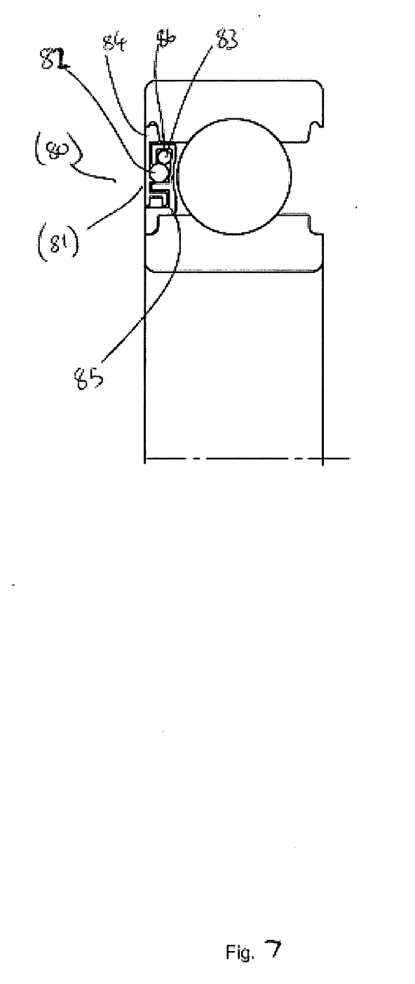

FIG. 7 is a longitudinal cross section of a bearing with an alternate non-contacting seal 80 of the invention.

From FIG. 7, said shut off valve 81 consists of a sealing elastomer 82 which is sealingly energised by member 83, which is also preferably an elastomeric member.

In bearing idleness, said elastomer 83 radially engages elastomer 82 and thereby creates a seal between the stator 84 and rotor 85.

In bearing operation, elastomer 83 displaces radially outwardly into a gap 86 thereby relieving the load on elastomer 82 permitting the sealing disengagement between the stator 84.

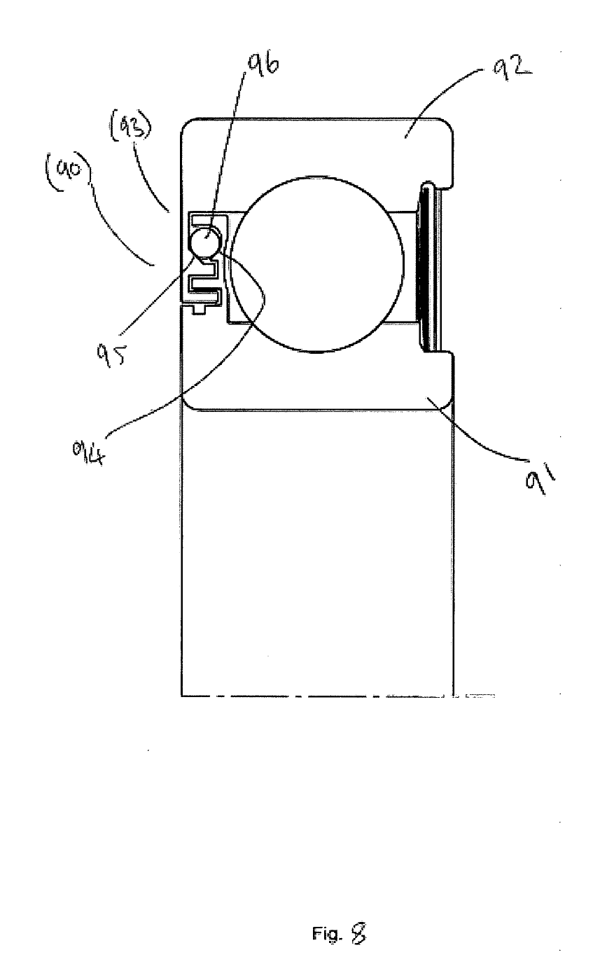

FIG. 8 is a longitudinal cross section of a bearing with an alternate and substantially integral non-contacting seal 90 of the invention.

From FIG. 8, the inner race 91 is radially extended to provide a complex series of radial and longitudinal castellations with a radially extended outer race 92.

Once again, the static shut off valve 93 is positioned between the rotor surface 94 and stator surface 95 and preferably comprises of an elastomeric member 96 which sealingly engages said surfaces 94 and 95 when the equipment is idle and sealingly disengages said surfaces 94 and 95 when the equipment is operational.

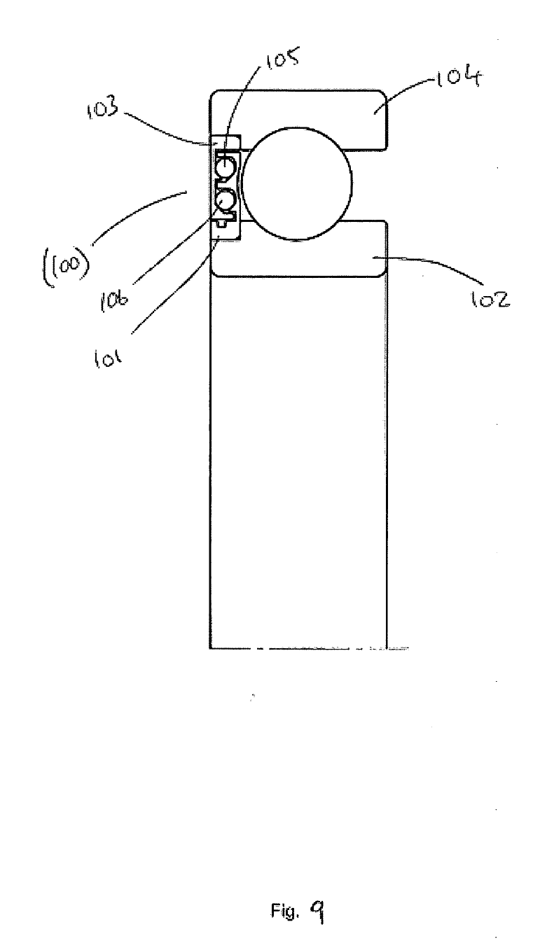

FIG. 9 is a longitudinal cross section of a bearing with an alternate non-contacting seal 100 of the invention.

From FIG. 9 the rotor 101 is positively secured to the inner race 102 and the stator 103 is positively secured to the outer race 104. Two or more elastomeric members 105 and 106 sealing engage on two or more surfaces of the stator 103 and two or more surfaces of the rotor 101 thereby providing dual sealing protection of the embodiment.

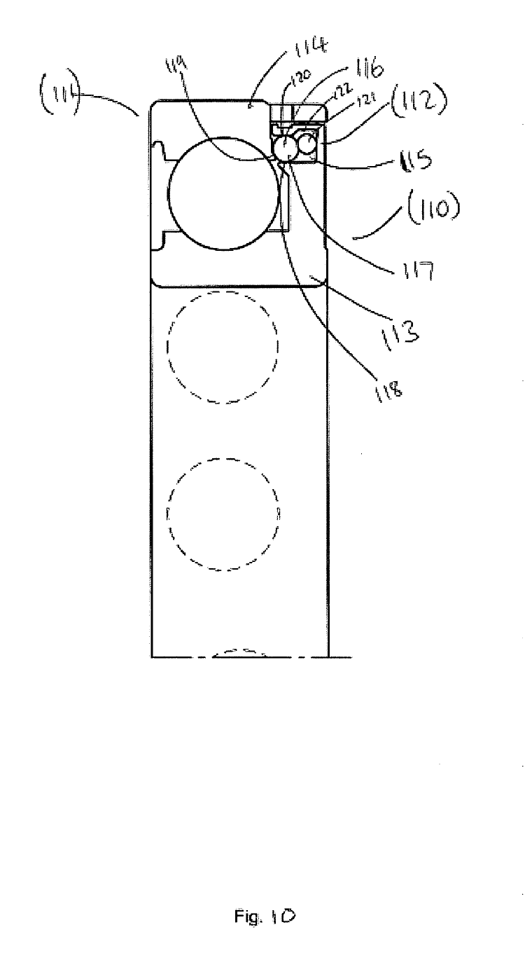

FIG. 10 is a longitudinal cross section of a bearing with an alternate non-contacting seal 110 of the invention whereby preferably the longitudinal width of the bearing 111 is extended beyond its existing width, to accommodate a static shut off valve 112 which is more longitudinally non-compact.

From FIG. 10 the rotor member 113 is radially extended to engage the stator 114, the to create a cavity 115 in which to house a static shut off valve 116. Preferably said shut off valve comprises of an elastomeric member 117 which sealingly engages said surfaces 118, 119 and 120 when the equipment is idle and sealingly disengages said stator surface 119 when the equipment is operational given member 121 radially displaces into gap 122 under the centrifugal forces exherted on it given the relative rotary motion of the rotor 113.

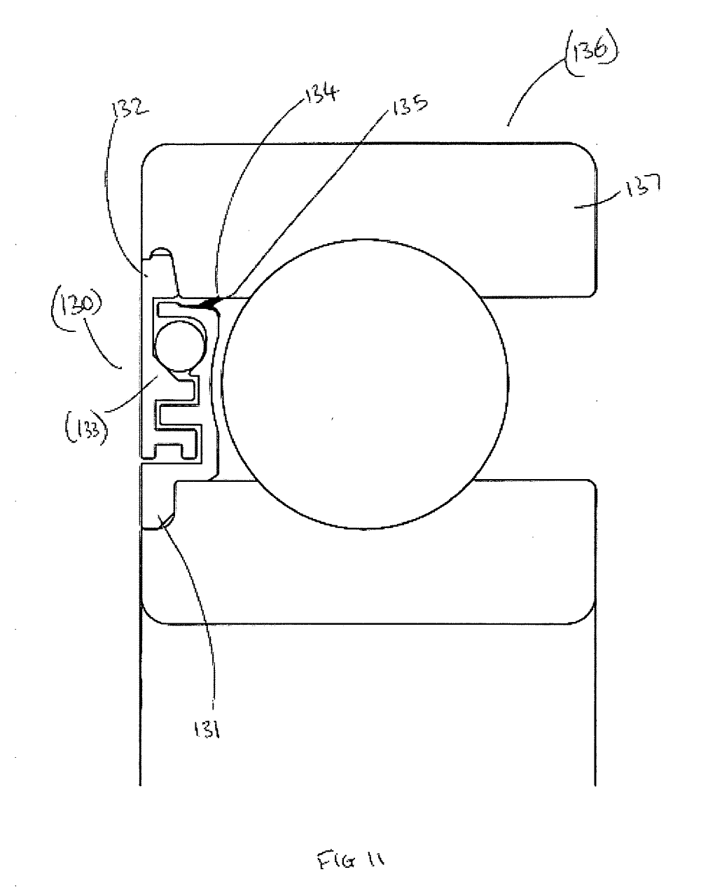

FIG. 11 is a longitudinal cross section of a bearing with an alternate non-contacting seal with integral lip type seal 130 of the invention.

From FIG. 11, the rotor 131, stator 132 and shut-off valve 133 operate in a manner as previously defined, however the rotor 131 as an elastomeric lip-type seal member 134 substantial attached to it and substantially in radial engagement with a stator surface 135.

Said rotor elastomeric member 134 provides a sealing engagement between the rotor 131 and stator 132 or, as shown the outer race 137 in both bearing 136 idle and operational conditions.

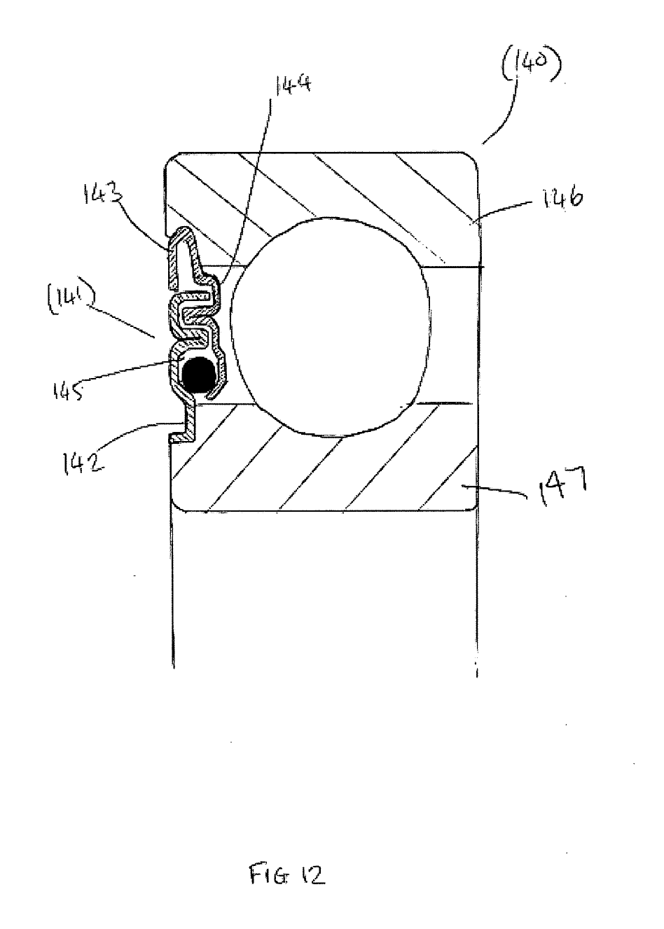

FIG. 12 is a longitudinal cross section of a bearing 140 with bearing seal 141, whereby said bearing seal 141 comprises of a rotor 142 and stator 143, one or more of which are manufactured from a pressed material such as sheet stainless steel.

Once again, the rotor 142 and stator 143 engage to provide a labyrinth path 144 and create a cavity 145 to house a static shut of valve 146, as previously defined.

The experience will however note from FIG. 12 that the parts are made from a press/stamping operation and therefore very appropriate for low cost mass production as found in the bearing industry.

Such pressed parts are ideally formed from material with a thickness of 0.1 mm to 1.5 mm, but preferably around 0.6 mm.

Clearly, preferably although not essential, a elastomeric type coating could be applied one or both of the pressed members, to provide a non-sparking advantage if the rotor 142 contacted the stator 143.
Equally, said elastomeric type coating could be solely applied to the interface between the stator 143 and the outer race 146 and/or the rotor 142 and the inner race 147, thereby providing a seal at each respective interface.

The design in FIG. 12 has tremendous commercial and technical advantage to be employed as a bearing seal for use as an integral part of a bearing.

The various embodiments of the design, therefore provide a means to prevent lubricant egress and/or moisture ingress in a bearing in both operational and idle bearing conditions.

Given the close proximity of the sealing aspects of the design to the bearing members, various embodiments of the invention specifically provide a bearing seal which, in its totality is longitudinally compact, defined as the longitudinal width of a commercially available elastomer, plus one or more material thickness of 0.1 mm or greater.

This specific longitudinal compactness of the sealing member is a vitally important embodiment of the present invention, specifically given the non-contacting labyrinth seal embodiment with a static shut-off device herein incorporated.

1-14. (canceled)

15. An isolator device, comprising:
a stator having a stator surface;
a rotor having a rotor surface; and,
a static shut-off device including at least one deformable toroidal member adjacent to the stator surface and adjacent to the rotor surface, said deformable toroidal member engaging both the stator surface and the rotor surface when said rotor is static and disengaging at least one of the stator surface and the rotor surface when said rotor is operational.

16. The isolator device according to claim 15, wherein said deformable toroidal member is not longitudinally coupled to said rotor or said stator by rotor or stator geometry adjacent to said deformable toroidal member.

17. The isolator device according to claim 15, further comprising a labyrinth seal formed between said rotor and said stator, said labyrinth seal comprising at least one radially or longitudinally extending feature in either said rotor or said stator adjacent to either the rotor surface or the stator surface.

18. The isolator device according to claim 15, wherein said static shut-off device is formed by at least one inclined surface of said stator and at least one inclined surface of said rotor, with said deformable toroidal member being between said at least one inclined surface of said stator and said at least one inclined surface of said rotor.

19. The isolator device according to claim 15, wherein said stator is made from a material having a thickness of between 0.1 and 2.0 mm.

20. The isolator device according to claim 15, wherein said rotor is made from a material having a thickness of between 0.1 and 2.0 mm.

21. The isolator device according to claim 15, wherein said deformable toroidal member is located adjacent to the stator surface and adjacent to the rotor surface, said deformable torodial member being energized by an additional toroidal member, said first deformable torodial member engaging both the rotor surface and the stator surface when said rotor is static and disengaging at least one of the rotor surface and the stator surface when said rotor is operational.

22. The isolator device according to claim 15, wherein said isolator device is a non-contacting sealing device.
